(19) United States
(12) Patent Application Publication
(10) Pub. No.: US 2013/0221895 A1
(43) Pub. Date: Aug. 29, 2013

(54) MOTOR DRIVE CIRCUIT

(71) Applicants: Mitsuhiko Kanda, Tokyo (JP); Akira Hatai, Tokyo (JP)

(72) Inventors: Mitsuhiko Kanda, Tokyo (JP); Akira Hatai, Tokyo (JP)

(73) Assignee: MITSUBISHI ELECTRIC CORPORATION, Chiyoda-ku, Tokyo (JP)

(21) Appl. No.: 13/882,325

(22) PCT Filed: Nov. 24, 2010
(86) PCT No.: PCT/JP2010/070890

§ 371 Date: Apr. 29, 2013

(51) Int. Cl. H02P 27/08

(52) U.S. Cl. CPC H02P 27/08
USPC 318/767

(57) ABSTRACT

A motor drive circuit that performs PWM driving of an AC motor includes: rectifying circuit that rectifies power from an AC power supply; a DC intermediate circuit that smoothes an output of the rectifying circuit and holds the smoothed output; an inverter circuit that executes a PWM control of a voltage applied to the AC motor based on DC power held in the DC intermediate circuit; and a filter circuit that is inserted between the AC power supply and the rectifying circuit, wherein the filter circuit includes a noise filter that is inserted between the AC power supply and the rectifying circuit and reduces harmonic noise, and a band elimination filter that is arranged at a posterior stage of the noise filter and reduces harmonic noise having a bandwidth, which can be generated by the PWM control.

### FIELD

The present invention relates to a motor drive circuit.

### BACKGROUND

In a power supply circuit described in Patent Literature 1 mentioned below as a conventional technique, there is disclosed a circuit configuration in which in a filter including a common-mode choke coil and two line bypass capacitors (so-called “Y capacitors”), respective inductance elements are inserted between the Y capacitors and a chassis ground to which each of the Y capacitors has to be connected, and a connection end of the inductance elements is connected to the chassis ground. According to this power supply circuit, it is supposed that a filter can be configured to have an attenuated frequency by a resonant frequency between the Y capacitors and the inductances, and unnecessary electromagnetic waves can be reduced.

### CITATION LIST

### Patent Literature

Patent Literature 1: Japanese Patent Application Laid-open No. 2008-182784

### SUMMARY

### Technical Problem

However, in a case of a motor drive circuit that performs pulse-width-modulation (PWM) driving of a motor, a harmonic noise component of a carrier frequency has a bandwidth. Therefore, there is a problem that a bandwidth of a band elimination filter including a Y capacitor and an inductance element becomes narrow, and there is a case where noise cannot be sufficiently removed.

The present invention has been achieved to solve the above problems, and an object of the present invention is to provide a motor drive circuit that can sufficiently suppress a harmonic noise component having a bandwidth without increasing a circuit size.

### Solution to Problem

In order to solve the aforementioned problems, a motor drive circuit that performs PWM driving of an AC motor according to one aspect of the present invention is configured in such a manner as to include: a rectifying circuit that rectifies power from an AC power supply; a DC intermediate circuit that smoothes an output of the rectifying circuit and holds the smoothed output; an inverter circuit that executes a PWM control of a voltage applied to the AC motor based on DC power held in the DC intermediate circuit; and a filter circuit that is inserted between the AC power supply and the rectifying circuit, wherein the filter circuit includes a noise filter that reduces harmonic noise that can be generated regardless of whether the PWM control is executed, and a band elimination filter that reduces harmonic noise having a bandwidth, which can be generated by the PWM control.

### Advantageous Effects of Invention

According to the present invention, a harmonic noise component having a bandwidth can be sufficiently suppressed without increasing a circuit size.

### BRIEF DESCRIPTION OF DRAWINGS

FIG. 1 is a configuration example of a motor drive circuit according to a first embodiment.

FIG. 2 is an explanatory diagram of harmonic noise that can be generated within the motor drive circuit when a PWM control is executed.

FIG. 3 depict an example of insertion loss characteristics of an LCR series circuit.

FIG. 4 is an explanatory diagram of functional distributions between a noise filter and a band elimination filter.

FIG. 5 is another configuration example of the motor drive circuit according to the first embodiment.

FIG. 6 is a configuration example of a motor drive circuit according to a second embodiment.

FIG. 7 is an example of circuit constants of a filter circuit unit according to a first simulation.

FIG. 8 depicts insertion loss characteristics of a first noise filter according to the first simulation.

FIG. 9 depicts insertion loss characteristics of a second noise filter according to the first simulation.

FIG. 10 depicts insertion loss characteristics of the whole filter circuit unit according to the first simulation.

FIG. 11 is an example of circuit constants of a second filter circuit according to a second simulation.

FIG. 12 depicts insertion loss characteristics of a second filter circuit unit according to the second simulation.

FIG. 13 depicts total insertion loss characteristics of the whole filter circuit unit according to the second simulation.

FIG. 14 depicts insertion loss characteristics (frequency difference between maximum insertion losses is 0%) of two second filter circuits according to a third simulation.

FIG. 15 depicts insertion loss characteristics (frequency difference between maximum insertion losses is 2.5%) of the two second filter circuits according to the third simulation.

FIG. 16 depicts insertion loss characteristics (frequency difference between maximum insertion losses is 2.5%) of the two second filter circuits according to the third simulation.

### DESCRIPTION OF EMBODIMENTS

Exemplary embodiments of a motor drive circuit according to the present invention will be explained below in detail with reference to the accompanying drawings. The present invention is not limited to the embodiments.

### First Embodiment

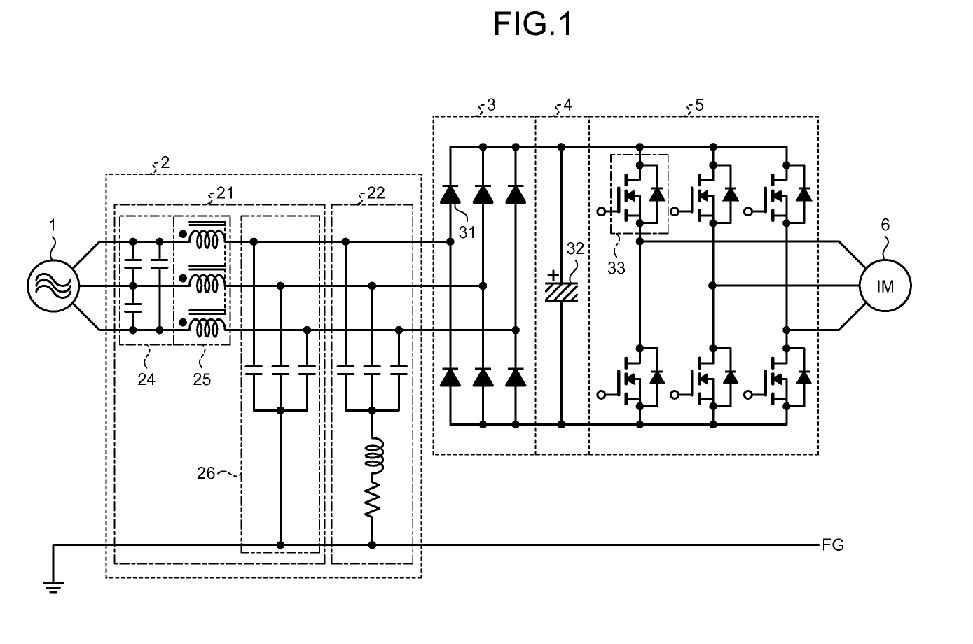

FIG. 1 is a configuration example of a motor drive circuit according to a first embodiment. As shown in FIG. 1, the motor drive circuit according to the first embodiment is configured to include a filter circuit 2, a rectifying circuit 3, a DC intermediate circuit 4, and an inverter circuit 5. In this motor drive circuit, power from an AC power supply (a three-phase AC power supply 1 is exemplified in FIG. 1) is rectified in the rectifying circuit 3 and smoothed in the DC intermediate circuit 4. The smoothed DC power is converted into AC power of a desired voltage and a desired frequency in the inverter circuit 5. The AC power is supplied to an AC motor 6 (a three-phase induction motor (IM) is exemplified in FIG. 1) connected to an output end (an AC output end) of the inverter circuit 5, thereby performing PWM driving of the AC motor 6.

The filter circuit 2 is configured to include a noise filter 21 connected to the three-phase AC power supply 1 and a band elimination filter 22 arranged at a posterior stage of the noise filter 21.

The noise filter 21 includes a first circuit unit 24 constituted by connecting across-the-line capacitors (so-called “X capacitors”) between each of the phases, a second circuit unit 25 constituted by inserting common-mode chokes respectively into those phases, and a third circuit unit 26 constituted by connecting one end of each of three Y capacitors to each of the three phases and connecting the other end to a frame ground (FG).

The band elimination filter 22 is configured to include three Y capacitors (two Y capacitors in a case of a single-phase AC power supply) and a series-connection circuit, wherein one end of each of the three Y capacitors is connected to each of three-phase power-supply lines connecting the three-phase AC power supply 1 and the rectifying circuit 3, while the other ends are connected to each other, and the series-connection circuit is constituted by a resistance element and an inductance element that are inserted between the frame ground (FG) and a connection end of the three Y capacitors.

While FIG. 1 depicts a configuration in which the series-connection circuit constituted by the resistance element and the inductance element is connected to the frame ground, the series-connection circuit can be connected to a terminal having the same potential as the frame ground.

Furthermore, while the band elimination filter 22 is arranged at a posterior stage of the third circuit unit 26 in the noise filter 21, the band elimination filter 22 can be arranged at an anterior stage of the third circuit unit 26.

The rectifying circuit 3 is configured to connect a diode element 31 in a full-bridge manner. The DC intermediate circuit 4 arranged at a posterior stage of the rectifying circuit 3 is configured to include a smoothing capacitor 32. The inverter circuit 5 arranged at a posterior stage of the DC intermediate circuit 4 is configured to connect three (in a case of a three-phase motor) arm circuits (legs) in parallel. In each of the arm circuits, switching elements 33 are connected in series. In each of the switching elements 33, a transistor element and a diode element are connected in inverse parallel.

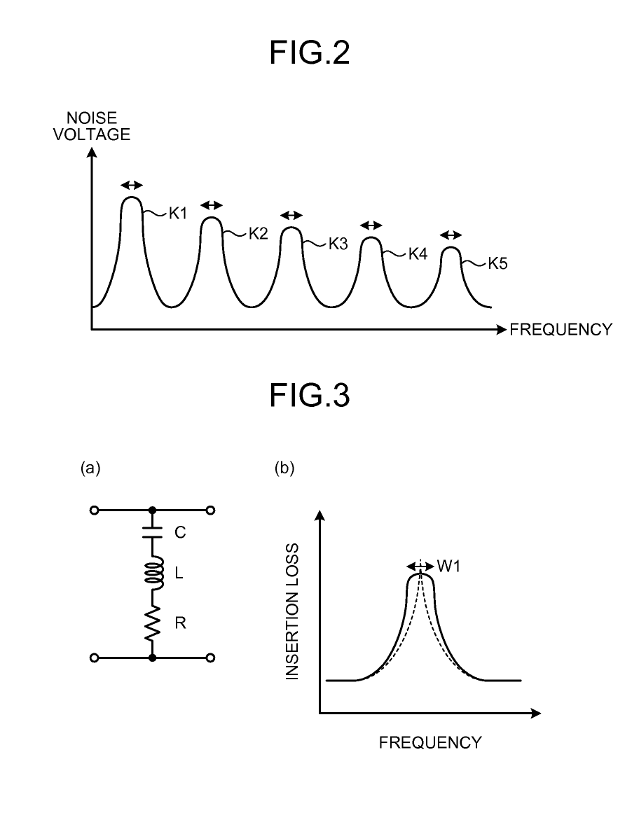

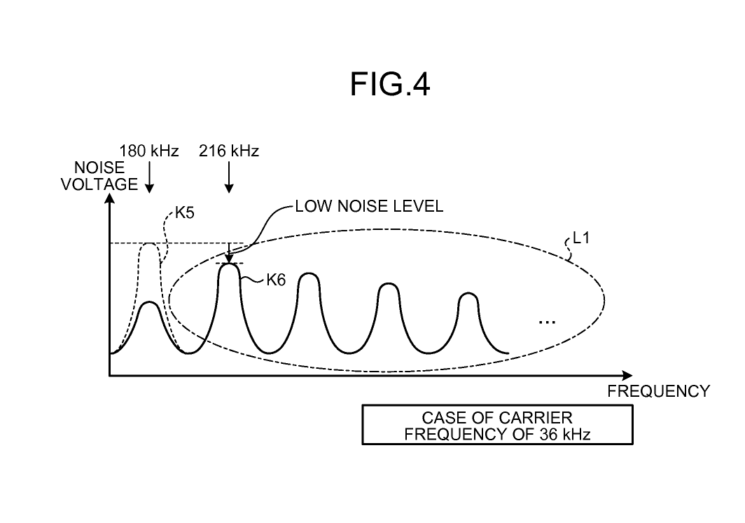

An outline of the motor drive circuit according to the first embodiment is explained next with reference to FIGS. 1 to 4. FIG. 2 is an explanatory diagram of harmonic noise that can be generated within the motor drive circuit when a PWM control is executed, FIG. 3 depict an example of insertion loss characteristics of an LCR series circuit, and FIG. 4 is an explanatory diagram of functional distributions between the noise filter 21 and the band elimination filter 22.

First, as a basic feature, when a pulse waveform with a duty ratio of 50% is expanded into the Fourier series, only harmonic noise components of an odd order such as the third order, the fifth order, and the seventh order (components of odd multiples of a fundamental frequency) appear in addition to a fundamental component, and no harmonic noise component of an even order appears. In a case of a repetitive waveform in which the pulse period remains unchanged and only the duty ratio is changed, the interval at which a noise peak appears remains unchanged while the order in which a harmonic noise component is increased is changed. A case where a PWM control is not executed corresponds to a waveform in which the duty ratio is constant within the repetitive period. A case where a PWM control is executed corresponds to a waveform in which the duty ratio is changed within the repetitive period.

When a switching element is switching-controlled, for example, in a case of a circuit such as a power supply circuit that does not execute a PWM control, harmonic noise components of respective orders appear in a periodic manner, and the harmonic noise components in which a fundamental frequency is a carrier frequency have a sharp waveform having a negligible bandwidth.

On the other hand, in a case of a circuit that executes a PWM control, such as the motor drive circuit according to the present embodiment, although the PWM control itself is executed periodically, the duty ratio is changed within the period of the PWM control. Therefore, while the feature that harmonic noise components appear in a periodic manner remains unchanged, the harmonic noise components in which a fundamental frequency is a carrier frequency appear as a waveform having a bandwidth.

Waveforms shown in FIG. 2 represent a fundamental noise component and harmonic noise components having the bandwidth as described above. In addition to a fundamental noise component K1, each of a second-order harmonic noise component K2, a third-order harmonic noise component K3, a fourth-order harmonic noise component K4, and a fifth-order harmonic noise component K5 also has a waveform having a bandwidth as shown by a double-headed arrow. Therefore, in the noise filter 21 shown in FIG. 1, there is a case where a noise component having a certain bandwidth cannot be sufficiently removed only by a filter that does not have a bandwidth, such as the third circuit unit 26.

FIG. 3(b) is an example of insertion loss characteristics of an LCR series circuit shown in FIG. 3(a), where an insertion loss of an LC series circuit that does not include an R component (a resistance component) is shown by a broken line and an insertion loss of an LCR series circuit including an R component is shown by a solid line. As shown in FIG. 3(b), by varying a value of a resistance inserted in series into the LC series circuit, a Q value (Quality Factor) that is an indicator of the sharpness of resonance can be changed (the Q value can be decreased), and it is possible to change sharp insertion loss characteristics to insertion loss characteristics having a certain bandwidth. A bandwidth W1 in the insertion loss characteristics can be determined according to a bandwidth of a noise voltage (see FIG. 2).

When the operation efficiency of a motor is increased or when a high-precision control is executed in a motor, it is effective to set a high carrier frequency. However, when the carrier frequency is set high, the noise level becomes high, and therefore it is necessary to enhance the performance of a noise filter. Also, there is a case where a low-order harmonic noise component of the carrier frequency appears around 150 kilohertz, which falls within the control target frequency range of conductive noise. FIG. 4 is an example of this case.

FIG. 4 depicts the fifth or higher order harmonic noise waveforms in a case of a carrier frequency of 36 kilohertz, in which the zero point on the horizontal axis represents 150 kilohertz, which is a lower-limit value of the control target frequency range. In the case of the carrier frequency of 36 kilohertz, the fifth-order harmonic noise corresponds to 180 (=36×5) kilohertz and the sixth-order harmonic noise corresponds to 216 (=36×6) kilohertz. That is, when the carrier frequency is set high, a low-order harmonic noise component, which does not appear when the carrier frequency is low, falls within the control target frequency range.

On the other hand, in the motor drive circuit according to the present embodiment, the fifth-order harmonic noise component K5 appearing around 180 kilohertz can be reduced by using the band elimination filter 22. The noise level of the sixth-order harmonic noise component K6 appearing at around 216 kilohertz or higher order harmonic noise components (noise components shown by a dotted dashed line L1) is lower as compared to the fifth-order harmonic noise component K5. Therefore, the sixth or higher order harmonic noise components can be reduced by the noise filter 21.

In a case where a band elimination filter having a bandwidth such as the band elimination filter 22 is not used, in the noise filter 21, it becomes necessary to perform an operation to connect the second circuit unit 25 and the third circuit unit 26 in multiple stages or to increase an inductance of the second circuit unit 25 or a capacitance value of the third circuit unit 26, for example. Therefore, there is a concern about an increase in volume of the whole filter circuit.

On the other hand, in the motor drive circuit according to the present embodiment, a low-order harmonic noise component can be reduced by using the band elimination filter 22. Therefore, it is possible to suppress an increase in volume and cost of the whole filter circuit even when a carrier frequency is set high.

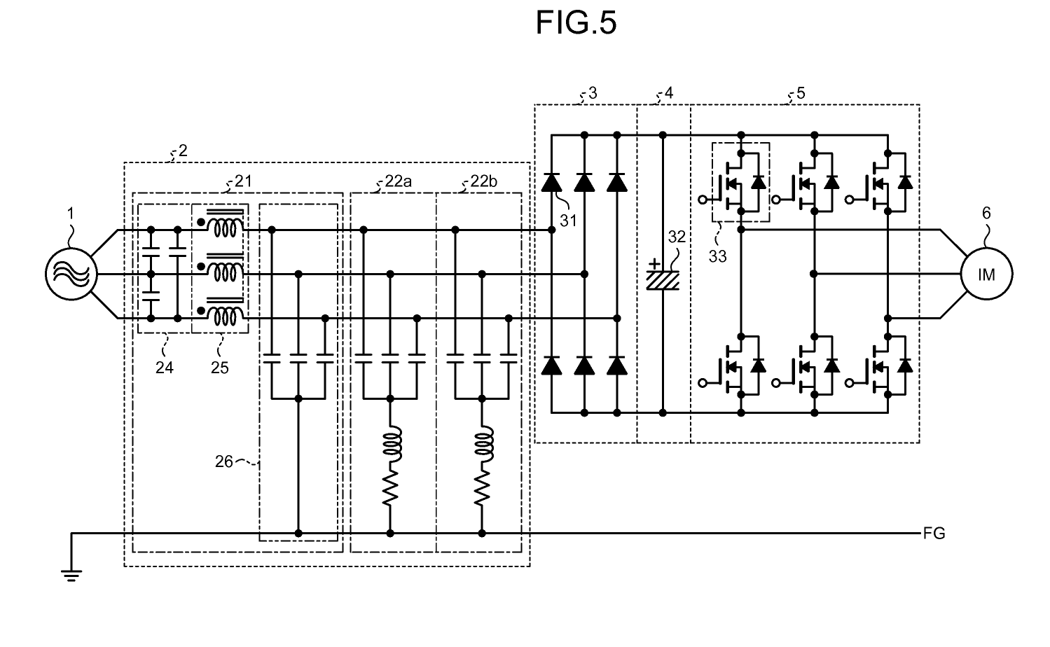

Assuming a case where a carrier frequency is set even higher to 52 kilohertz, for example, third-order harmonic noise corresponds to 156 (=52×3) kilohertz, fourth-order harmonic noise corresponds to 208 (=52×4) kilohertz, and fifth-order harmonic noise corresponds to 260 (=52×5) kilohertz. In this case, there is a possibility that the level of either a fourth-order harmonic noise component or a fifth-order harmonic noise component is high and cannot be reduced to a specified level only by the noise filter 21. In such a case, as shown in FIG. 5, it suffices that the band elimination filter 22 is connected in multiple stages. For example, a band elimination filter 22a is used to reduce a third-order harmonic noise component, and a band elimination filter 22b is used to reduce either a fourth-order harmonic noise component or a fifth-order harmonic noise component, which has a higher noise level.

As explained above, in the motor drive circuit according to the first embodiment, in a filter circuit inserted between an AC power supply and a rectifying circuit, a noise filter included in the filter circuit reduces harmonic noise that can be generated regardless of whether a PWM control is executed, and a band elimination filter provided in the filter circuit reduces harmonic noise having a certain bandwidth, which can be generated by the PWM control. Therefore, the necessity of enhancing the performance of the noise filter is reduced, and an increase in cost of the whole filter circuit and an increase in volume thereof caused by mounted components can be suppressed.

Furthermore, in the motor drive circuit according to the first embodiment, a carrier frequency can be set high, and therefore it becomes possible to reduce a motor loss and execute a high-precision control to a motor.

### Second Embodiment

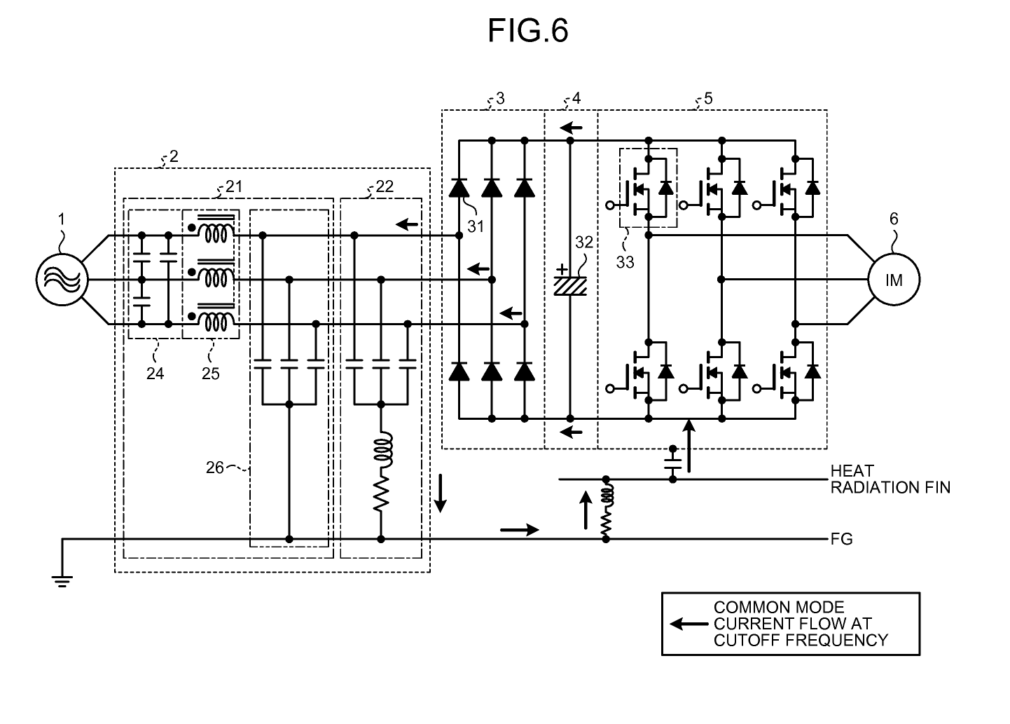

FIG. 6 is a configuration example of a motor drive circuit according to a second embodiment. In the motor drive circuit in FIG. 6, a stray capacitance that can exist between a casing having the inverter circuit 5 accommodated therein and a heat radiation fin that cools a switching element in the inverter circuit 5, and a parasitic inductance and a parasitic resistance that can be generated between the heat radiation fin and an FG are shown. These stray capacitance, parasitic inductance, and parasitic resistance are stray components (parasitic components) that can exist on a noise path extending between the band elimination filter 22 and the inverter circuit 5. When their values are large enough not to be ignored relative to values of a capacitor, an inductance element, and a resistance element in the band elimination filter 22, there is a possibility that a common mode current can flow on a path extending along arrows shown in FIG. 6. When there is such a path through which a common mode current flows as described above, the magnitude of a resonant current becomes different from a theoretical value, and therefore there is a possibility that a resonant frequency can also deviate from a theoretical value.

Therefore, in the motor drive circuit according to the second embodiment, values of the capacitor, the inductance element, and the resistance element in the band elimination filter 22 or the band elimination filters 22a and 22b are determined by considering values of the stray capacitance, parasitic inductance, and parasitic resistance mentioned above. In a case where the values of these stray capacitance, parasitic inductance, and parasitic resistance can be estimated with a certain degree of accuracy by a simulation or the like, it suffices that these estimated values are used to determine the values of the capacitor, the inductance element, and the resistance element.

On the other hand, in a case where it is difficult to estimate the values of the stray capacitance, parasitic inductance, and parasitic resistance, it suffices that at least one of the resistance element and also the capacitor and the inductance element in the band elimination filter 22 (22a and 22b) is adjusted as a variable element.

As explained above, in the motor drive circuit according to the second embodiment, an inductance, a capacitance value, and a resistance value of a band elimination filter are determined by considering a stray capacitance, a parasitic inductance, and a parasitic resistance that can exist on a noise path extending between the band elimination filter and an inverter circuit. Therefore, it is possible to adjust filter characteristics of the band elimination filter to a desired frequency, and accordingly improvements in cutoff characteristics can be achieved.

(First Simulation Results)

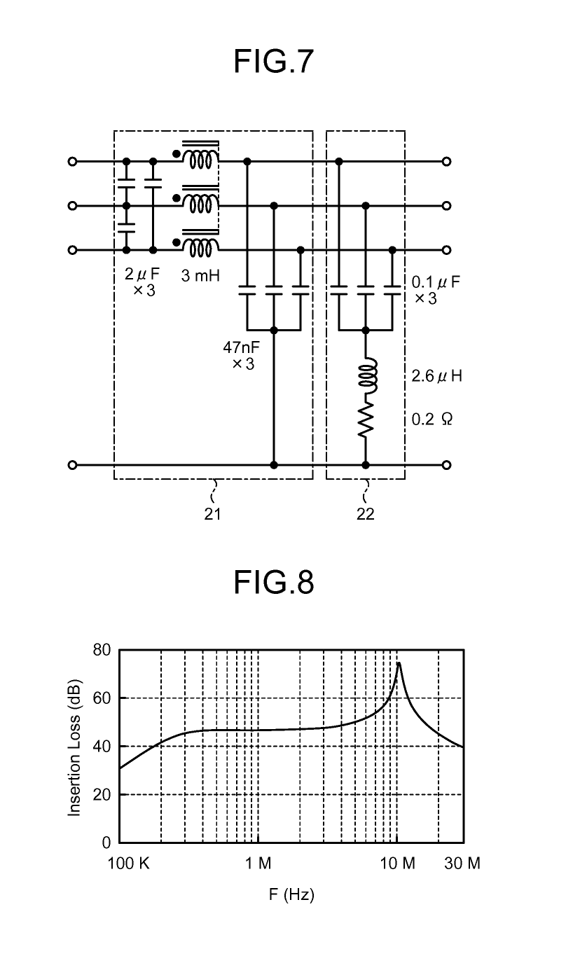

First simulation results of the motor drive circuit according to the first and second embodiments are explained next with reference to FIGS. 7 to 10. Insertion loss characteristics are shown in FIGS. 8 to 10 while taking a stray capacitance, a parasitic inductance, and a parasitic resistance into consideration.

First, circuit constants of a filter circuit unit according to the first simulation are as shown in FIG. 7. In this case, insertion loss characteristic of the noise filter 21 is as shown in FIG. 8, and can yield an insertion loss of 40 dB or higher across a band from 200 kilohertz to 30 megahertz.

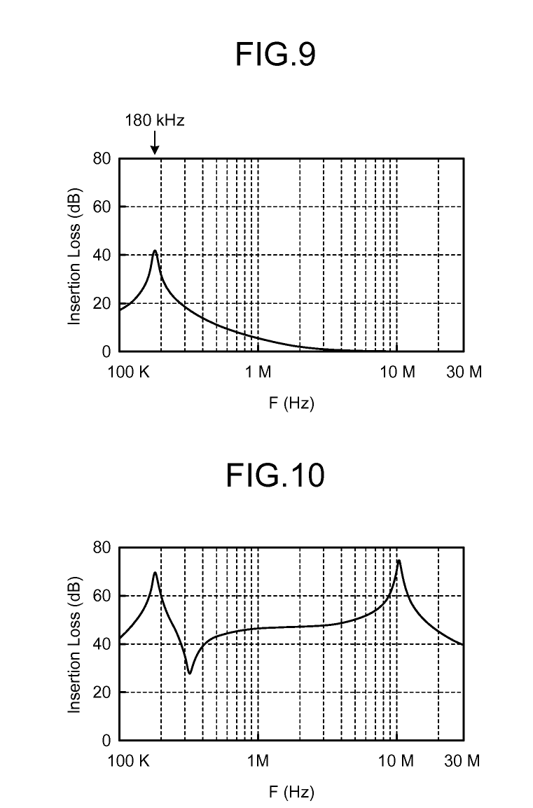

In the case of the circuit constants shown in FIG. 7, insertion loss characteristic of the band elimination filter 22 is as shown in FIG. 9, and can yield an insertion loss of 40 dB or higher to a harmonic noise component of 180 kilohertz. FIG. 10 depicts a combination of the characteristics shown in FIG. 8 and in FIG. 9. That is, FIG. 10 depicts insertion loss characteristics of the whole filter circuit unit combining the noise filter 21 and the band elimination filter 22 (total insertion loss characteristics). While the filter characteristic shown in FIG. 8 alone exhibits an insufficient ability to reduce a low-order harmonic noise component, a desired filter characteristic is obtained by adding the insertion loss characteristic of the band elimination filter 22 shown in FIG. 9.

In the total insertion loss characteristics shown in FIG. 10, although it is not clear from the waveforms shown in FIG. 10, when a peak waveform around 180 kilohertz and a peak waveform around 10 megahertz are compared, the peak waveform around 180 kilohertz is wider. The peak waveform around 180 kilohertz is obtained by setting a resistance value to 0.2Ω in the band elimination filter 22 in FIG. 7, and has filter characteristics preferable to a harmonic noise component having a bandwidth.

(Second Simulation Results)

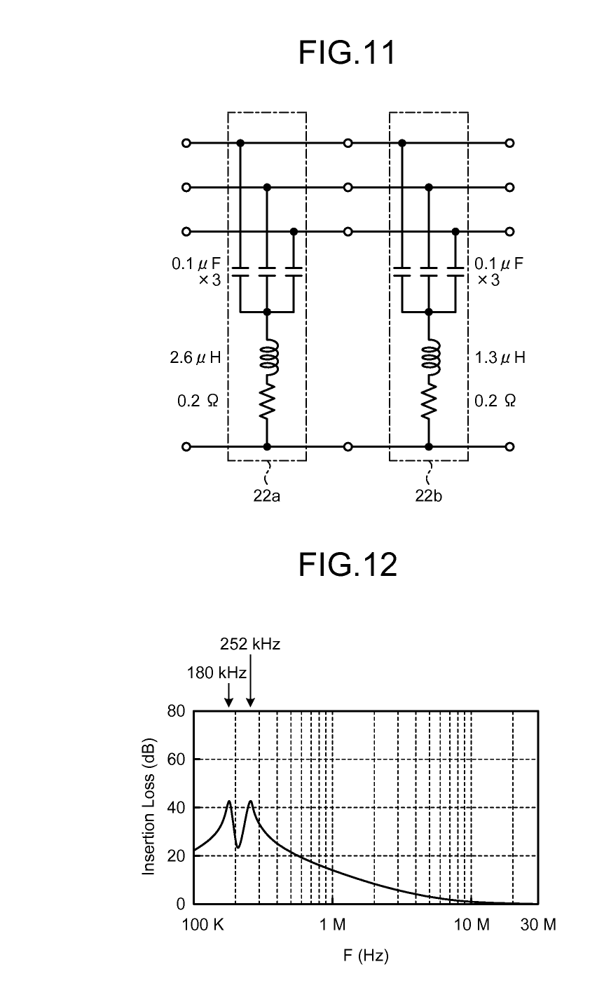

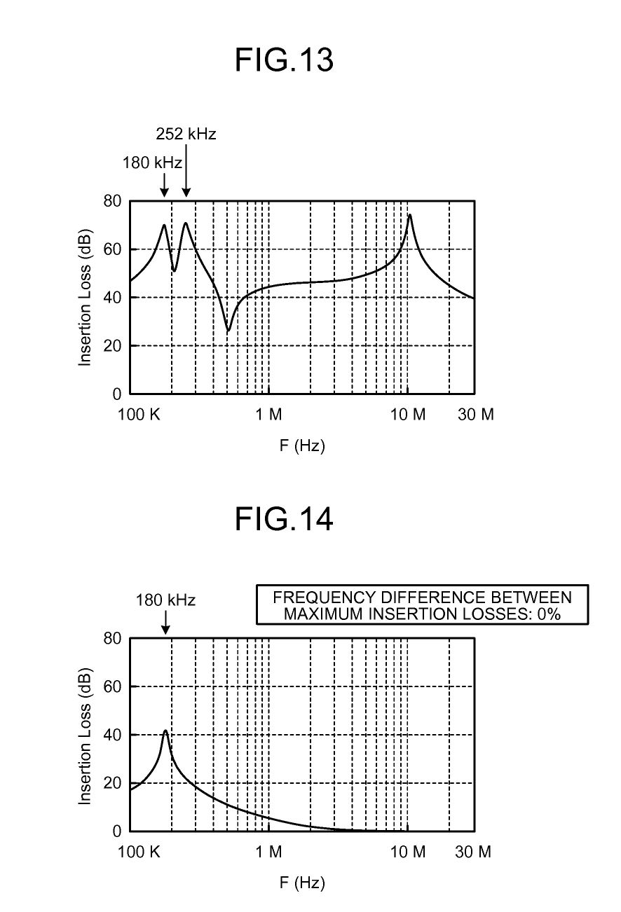

Second simulation results of the motor drive circuit according to the first and second embodiments are explained next with reference to FIGS. 11 to 13. Similarly to the first simulation results, insertion loss characteristics are shown in FIGS. 12 and 13 while taking a stray capacitance, a parasitic inductance, and a parasitic resistance into consideration.

Circuit constants of a second filter circuit according to the second simulation are shown in FIG. 11. In this case, insertion loss characteristics of the band elimination filters 22a and 22b are shown in FIG. 12, and can yield an insertion loss of 40 dB or higher to each of harmonic noise components of 180 kilohertz (the fifth order) and 252 kilohertz (the seventh order).

FIG. 13 depicts a combination of the characteristics shown in FIG. 8 and in FIG. 12, in which total insertion loss characteristics of the whole filter circuit unit combining the noise filter 21 and the band elimination filter 22 are shown. While the filter characteristic shown in FIG. 8 alone exhibits an insufficient ability to reduce a low-order harmonic noise component, a desired filter characteristic is obtained by adding the insertion loss characteristics of the band elimination filters 22a and 22b shown in FIG. 13.

### Third Embodiment

A motor drive circuit according to a third embodiment is explained next. The configuration of the motor drive circuit according to the third embodiment is identical or equivalent to that shown in FIG. 5. In the first embodiment, the band elimination filters 22a and 22b of a two-stage configuration function as a band elimination filter that reduces different low-order harmonic noise components. However, in the third embodiment, two band elimination filters 22a and 22b reduce one low-order harmonic noise component.

(Third Simulation Results)

An operation according to the third embodiment is explained by third simulation results according to the third embodiment.

First, circuit constants of the band elimination filter 22a according to the third simulation are as shown in FIG. 11. In contrast, among circuit constants of the band elimination filter 22b, a capacitance value and a resistance value are the same as those of the band elimination filter 22a while an inductance is variable.

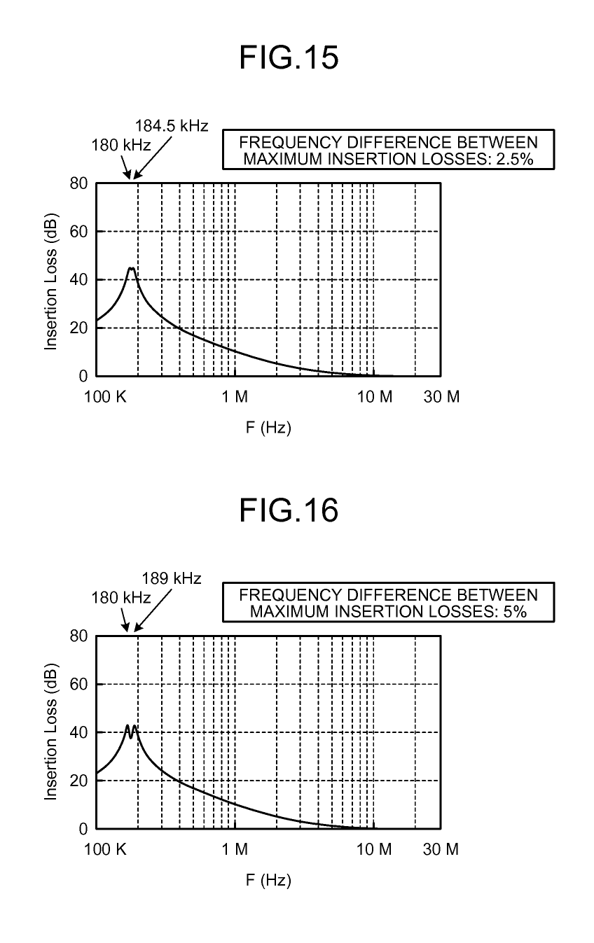

When the simulation results shown in FIGS. 14 to 16 are examined, FIG. 14 depicts a case where the frequency difference between the maximum insertion losses is 0%, that is, a case where band elimination filters having the same circuit constants are configured to be a two-stage configuration. FIG. 15 depicts a case where the frequency difference between the maximum insertion losses is 2.5%. Because the frequency difference is 2.5%, there is a difference of 4.5 (=180×2.5/100) kilohertz between a center value of a cutoff frequency in one of band elimination filters and a center value of a cutoff frequency in the other band elimination filter. As described above, a filter configuration according to the third embodiment is a staggered filter configuration using two-stage band elimination filters in which center values of their cutoff frequencies deviate from each other by a predetermined amount.

FIG. 16 depicts a case where the frequency difference between the maximum insertion losses is 5%, in which there is a difference of 9 (=180×5/100) kilohertz between a center value of a cutoff frequency in one of band elimination filters and a center value of a cutoff frequency in the other band elimination filter. In FIG. 16, a dip of about 6 dB is generated between the frequencies of 180 kilohertz and 189 kilohertz. However, such a dip of about 6 dB is within an allowable range. While FIGS. 15 and 16 depict simulation results in which a staggered frequency is shifted to a higher cutoff-frequency side, the staggered frequency can be shifted to a lower cutoff-frequency side. For example, when the frequency difference between the maximum insertion losses is 2.5%, the center values of the cutoff frequencies in the two-stage band elimination filters are 175.5 kilohertz and 180 kilohertz.

As explained above, in the motor drive circuit according to the third embodiment, filter characteristics having a bandwidth are achieved by a staggered filter using two-stage band elimination filters in which center values of their cutoff frequencies deviate from each other by a predetermined amount. Therefore, it is possible to change characteristics of the band elimination filters to those having a bandwidth without decreasing a Q value of the band elimination filters, that is, without changing their sharp characteristics.

### Fourth Embodiment

In a fourth embodiment, a switching element included in the inverter circuit 5 in the motor drive circuit is explained. As a switching element used in the motor drive circuit, a switching element configured to connect a semiconductor transistor element (such as an insulated-gate bipolar transistor (IGBT) and a metal oxide semiconductor filed-effect transistor (MOSFET)) of a silicon (Si) material and a semiconductor diode element of an Si material in inverse parallel is generally used. The techniques explained in the first to third embodiments can be used in an inverter unit and a converter unit that include this general switching element.

Meanwhile, the techniques according to the first to third embodiments described above are not limited to a switching element formed of an Si material. It is needless to mention that, in place of the Si material, it is also possible to use the techniques according to the first to third embodiments for the inverter circuit 5 including a switching element of a silicon carbide (SiC) material, which is receiving attention in recent years.

SiC has characteristics of being able to be used at a high temperature. Therefore, when a switching element of an SiC material is used as a switching element included in the inverter circuit 5, an allowable operation temperature of a switching element module can be increased to a high temperature. Accordingly, it is possible to increase a carrier frequency to increase a switching speed. However, a motor drive circuit that executes a PWM control has the problems of low-order harmonic noise and harmonic noise having a bandwidth as described above. Therefore, it is difficult to execute a control for simply increasing a carrier frequency without providing any solution to overcome these problems.

As described above, according to the techniques of the first to third embodiments, the motor drive circuit that executes a PWM control can solve problems of low-order harmonic noise and harmonic noise having a bandwidth, which are caused due to an increase of a carrier frequency. Therefore, even when a switching speed is increased by using a switching element of an SiC material, it is possible to increase the operation efficiency of a motor while overcoming the problems of harmonic noise.

SiC is an example of a semiconductor referred to as “wide bandgap semiconductor” because of its wider bandgap properties than Si. In addition to this SiC, a semiconductor formed of a gallium nitride-based material or diamond also belongs to the wide bandgap semiconductor. Their properties are similar to those of SiC in many respects. Therefore, a configuration using the wide bandgap semiconductor other than SiC also constitutes the scope of the present invention.

A transistor element and a diode element that are formed of the wide bandgap semiconductor described above have a high voltage resistance and a high allowable current density. Therefore, it is possible to downsize the transistor element and the diode element. Accordingly, by using these downsized transistor element and diode element, it is possible to downsize a semiconductor module having these elements incorporated therein.

Furthermore, the transistor element and diode element formed of the wide bandgap semiconductor have a high heat resistance. Therefore, it is possible to downsize a heat sink, and accordingly it is possible to further downsize the switching element module.

Further, the transistor element and diode element formed of the wide bandgap semiconductor have low power loss. Therefore, it is possible to achieve high efficiency of the switching element and the diode element, and accordingly it is possible to achieve high efficiency of the switching element module.

The configuration explained in the first to fourth embodiments described above is only an example of the configuration of the present invention. The configuration can be combined with other well-known techniques, and it is needless to mention that the present invention can be configured while modifying it without departing from the scope of the invention, such as omitting a part the configuration.

### INDUSTRIAL APPLICABILITY

As described above, the motor drive circuit according to the present invention is useful as an invention that can sufficiently suppress a harmonic noise component having a bandwidth without increasing a circuit size.

### REFERENCE SIGNS LIST

1 three-phase AC power supply
2 filter circuit
3 rectifying circuit
4 DC intermediate circuit
5 inverter circuit
6 AC motor
21 noise filter
22, 22a, 22b band elimination filter
24 first circuit unit (noise filter)
25 second circuit unit (noise filter)
26 third circuit unit (noise filter)
31 diode element
32 smoothing capacitor
33 switching element

1. A motor drive circuit that performs PWM driving of an AC motor, the motor drive circuit comprising:
a rectifying circuit that rectifies power from an AC power supply;
a DC intermediate circuit that smoothes an output of the rectifying circuit and holds the smoothed output;
an inverter circuit that executes a PWM control of a voltage applied to the AC motor based on DC power held in the DC intermediate circuit; and
a filter circuit that is inserted between the AC power supply and the rectifying circuit, wherein
the filter circuit includes
a noise filter that is inserted between the AC power supply and the rectifying circuit and reduces harmonic noise that can be generated regardless of whether the PWM control is executed, and
a band elimination filter that is arranged at a posterior stage of the noise filter and reduces harmonic noise having a bandwidth, which can be generated by the PWM control, and wherein
the band elimination filter is configured to include
a plurality of capacitors, one end of each being connected to each of phase power-supply lines connecting the AC power supply and the rectifying circuit, and the other ends being connected to each other, and
a series-connection circuit constituted by a resistance element and an inductance element that are inserted between a connection end of the capacitors and a frame ground or a terminal having the same potential as the frame ground.

2. (canceled)

3. The motor drive circuit according to claim 1, wherein an inductance, a capacitance value, and a resistance value of the band elimination filter are determined by considering a stray capacitance, a parasitic inductance, and a parasitic resistance that can exist on a noise path extending between the band elimination filter and the inverter circuit.

4. The motor drive circuit according to claim 1, wherein the band elimination filter is configured by connecting a plurality of band elimination filters with different cutoff frequencies in multiple stages.

5. The motor drive circuit according to claim 4, wherein in at least two of the band elimination filters, a processing target of one band elimination filter and a processing target of the other band elimination filter are different harmonic noise components among harmonic noise components in which a fundamental frequency is a carrier frequency.

6. The motor drive circuit according to claim 4, wherein in at least two of the band elimination filters, a frequency difference between a center value of a cutoff frequency in one band elimination filter and a center value of a cutoff frequency in the other band elimination filter is set within ±5% of a cutoff frequency in the one or the other band elimination filter.

7. The motor drive circuit according to claim 1, wherein switching elements included in the inverter circuit are each formed of a wide bandgap semiconductor.

8. The motor drive circuit according to claim 7, wherein the wide bandgap semiconductor is a semiconductor using a silicon carbide material, a gallium nitride-based material, or diamond.
